(19) United States
(12) Patent Application Publication
(10) Pub. No.: US 2007/0092050 A1
(43) Pub. Date: Apr. 26, 2007

(54) Microwave-powered pellet accelerator

(76) Inventors: Paul B. Parks, San Diego, CA (US); Francis W. Perkins, La Jolla, CA (US)

Correspondence Address: Attn: NEIL K. NYDEGGER;NYDEGGER & ASSOCIATES, 348 Olive Street, San Diego, CA, 92103, US

(21) Appl. No.: 11/256,662

(22) Filed: Oct. 21, 2005

(51) Int. Cl. H05H 1/22

(52) U.S. Cl. 376/100

(57) ABSTRACT

A system for fueling a tokamak includes a gyrotron for radiating microwave energy into a waveguide. Also included is a module having a deutritium-tritium (DT) fuel pellet, a diamond/sapphire window, and a pusher medium located between the pellet and window that is made of frozen deuterium (D₂) and metallic particles. With the module in the waveguide, the gyrotron is activated. Radiation from the gyrotron is then directed into the waveguide and through the window to cause a gaseous expansion of the pusher medium. This ejects the pellet from the waveguide and into the plasma of the tokamak.

### FIELD OF THE INVENTION

The present invention pertains generally to systems and methods for fueling energy generating apparatus. More particularly, the present invention pertains to systems and methods for injecting fuel pellets into the plasma of a tokamak while controlling the core plasma density in the reactor. The present invention is particularly, but not exclusively, useful for systems and methods that use microwave energy to achieve high velocity fuel pellet injection into the plasma of a tokamak.

### BACKGROUND OF THE INVENTION

Several applications can be envisioned wherein a projectile needs to be quickly accelerated from standstill to a very high velocity (e.g. 3-5 km/sec). For such applications, there are, obviously, certain constraints that require special consideration. For instance, when the acceleration path of the particle is curved, as opposed to being straight, centrifugal acceleration forces are created on the projectile. These forces then present additional constraints for consideration. In particular, any limitations the centrifugal acceleration forces may impose on the acceleration of the projectile must be evaluated. Even when a straight acceleration path is available, access to the path may become a significant concern. Add to this other considerations, such as a need to accelerate a series of projectiles at a high repetition rate, and a need to achieve reliable acceleration, and it becomes clear that each application requires special consideration.

As implied above, for specific instances wherein a projectile must be moved along a path that necessarily includes curves, the tortuous nature of the path can severely limit velocity of the projectile. A tokamak presents just such a situation. Of particular concern with a tokamak, insofar as the acceleration of projectiles may be of concern, is the ability to fuel plasma in the tokamak using projectiles (i.e. fuel pellets). It happens, however, that for several reasons, the use of fuel pellets for this purpose may be very desirable. Indeed, it is a standard practice to fuel tokamaks by injecting frozen hydrogenic pellets into the plasma chamber.

It is well known that a tokamak is more efficiently fueled, if the fuel can be delivered into the plasma from its inner wall. To benefit from this advantage, however, fuel pellets need to travel from outside the tokamak cage and then through the cage to the inner wall of the plasma. This necessarily takes the pellet along a path that is quite tortuous. Even with this advantage, in order to ensure good plasma penetration by the fuel pellets, and to have density control flexibility, it is still necessary that the fuel pellet be injected into the plasma at very high velocities. Heretofore, the practice has been to rely on whatever velocity can be practicably attained when acceleration of the pellet is accomplished before the pellet enters the tokamak cage.

In light of the above, it is an object of the present invention to provide systems and methods for accelerating projectiles (fuel pellets), wherein the pellet is moved at a relatively low velocity through a tokamak cage until the pellet is in position for rapid acceleration and injection into the plasma chamber of the tokamak. Another object of the present invention is to provide systems and methods for accelerating projectiles (fuel pellets) wherein a propulsion force on the pellet is initiated using microwave energy. Still another object of the present invention is to provide systems and methods for accelerating projectiles (fuel pellets) that are easy to use, are relatively simple to operate, and are comparatively cost effective.

### SUMMARY OF THE INVENTION

A system for providing fuel to a tokamak includes a waveguide, and a gyrotron for directing microwave energy into the waveguide. Also, the system includes a module that is pre-positioned in the waveguide to interact with microwave energy from the gyrotron. The result of this is that a fuel pellet in the module is ejected from the waveguide and into the plasma chamber to fuel the tokamak.

In accordance with the present invention, the waveguide has a substantially straight section that extends between a first end and a second end. This straight section also has a predetermined, substantially uniform cross-sectional area along its length. In combination with the waveguide, the gyrotron mentioned above is used to radiate microwave energy into the straight section. Specifically, the radiation from the gyrotron is directed by the waveguide from the first end of the straight section toward its second end. Accordingly, the second end of the waveguide's straight section is connected in communication with the plasma chamber of the tokamak.

The module that is used for the present invention has several distinct components. In particular, the module includes a fuel pellet that will be used for fueling the plasma in the chamber of the tokamak. Along with the fuel pellet, the module also includes a window and a pusher medium that is positioned between the pellet and the window. Additionally, the module can include a metallic reflector (e.g. a Lithium foil). If used, the metallic reflector is positioned between the fuel pellet and the pusher medium. Importantly, the assembled module, and all of its constituent components, are dimensioned for insertion into the straight section of the waveguide.

In greater detail, the fuel pellet of the module is made of deutritium- tritium (DT). The window is made of either diamond or sapphire. And, the pusher medium comprises a mixture of frozen deuterium (D₂) and metallic particles. More specifically, the metallic particles in the pusher medium are preferably disc-shaped conductors that are made of lithium (Li) and have a radius “a” of about four microns (a=4 μm) and a thickness “h” of about four-tenths of a micron (h=0.4 μm). The metallic particles, however, could as well be shaped as loops or spheres. Despite their particular shape, in all instances it is preferable that there be a separation distance between the metallic particles of approximately five microns. Further, it is also preferable that the concentration of metallic particles in the pusher medium be less than about ten percent of the volume of the pusher medium.

In the operation of the system of the present invention, a module is first positioned in the straight section of the waveguide. This can be done in either of two ways. For one, a complete module is pre-assembled outside the waveguide. It is then released into the waveguide so that the module enters the straight section of the waveguide through its first end. For the other, the diamond/sapphire window is permanently affixed to the waveguide, in the straight section, at its first end. Only the pusher medium, metallic reflector and fuel pellet are then pre-assembled, outside the waveguide. This combination is then released into the waveguide so that it enters the straight section of the waveguide through the second end for subsequent contact of the pusher medium with the window. In either case, a complete module is created and positioned inside the waveguide.

Once a module has been positioned, and is in place in the straight section of the waveguide, the gyrotron is activated. Radiation from the gyrotron is then directed by the waveguide through the window of the module to interact with the pusher medium. This causes a gaseous expansion of the pusher medium. In turn, the expansion ejects the fuel pellet from the waveguide and into the plasma chamber of the tokamak.

As intended for the present invention, the gyrotron will have a high power radiation output that is in a range between approximately one and two megawatts (1-2 MW). Further, the microwave energy in the radiation will preferably be selected to have a wavelength “λ” that will effectively interact with the metallic particles for absorption of the radiation in the pusher medium. In general, wavelengths greater than about one millimeter (λ>1 mm) suffice for this purpose. The import here is to heat and vaporize the deuterium (D₂) of the pusher medium and, thereby, cause the pusher medium to expand as a gas. Consequently, as the pusher medium expands, the fuel pellet will be ejected from the waveguide and into the plasma chamber. As envisioned for the present invention, the ejection of fuel pellets can be accomplished at a velocity above three kilometers per second.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a module in accordance with the present invention;

FIG. 2 is a cross section view of a tokamak showing an incorporation of a system of the present invention;

FIG. 3A is a perspective view of a waveguide as it receives a module for subsequent module activation;

FIG. 3B is a view of the waveguide shown in FIG. 3A with the module positioned for activation;

FIG. 4A is a perspective view of an alternate embodiment of a waveguide as it receives a module for subsequent module activation; and

FIG. 4B is a view of the waveguide shown in FIG. 4A with the module positioned for activation.

### DESCRIPTION OF THE PREFERRED EMBODIMENTS

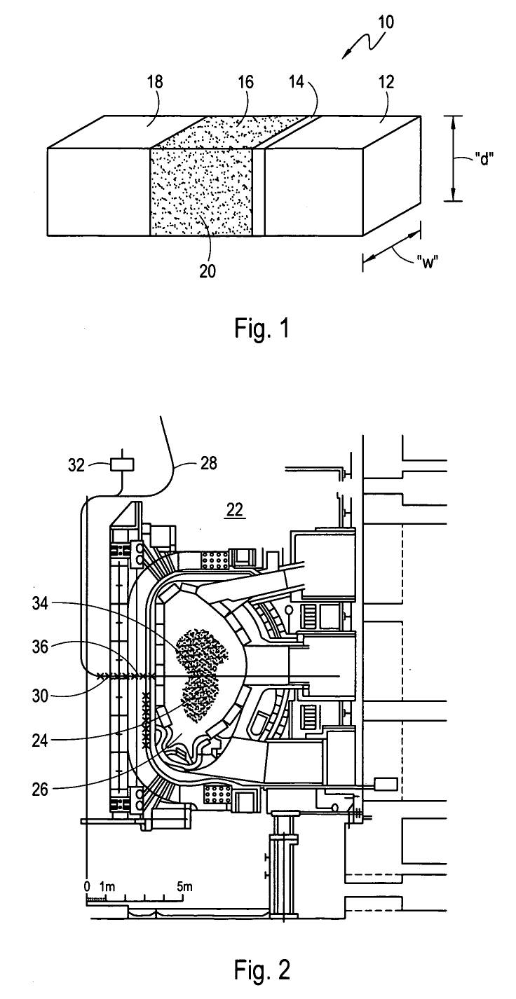

Referring initially to FIG. 1 a module for use with the systems and methods of the present invention is shown and is generally designated 10. More specifically, FIG. 1 shows that the module 10 includes, in combination, a fuel pellet 12, a reflector 14, a pusher medium 16 and a window 18. For operational reasons, the order in which components of the module 10 are assembled for the present invention is important, and is not arbitrary. Specifically, the reflector 14, if used, is positioned between the fuel pellet 12 and the pusher medium 16, as shown. Note: the reflector 14 may be omitted if desired. If so, then the fuel pellet 12 is juxtaposed with the pusher medium 16. In either case, with or without the reflector 14, the window 18 is juxtaposed with the pusher medium 16, and is positioned in the module 10 opposite the fuel pellet 12.

In addition to the order in which components of the module 10 are assembled, the materials used for the various components of the module 10 are important. For example, the fuel pellet 12 for module 10 is preferably frozen deutritium-tritium (DT). Depending on the particular application, however, the fuel pellet 12 can be made of any composition of matter that can be accelerated as a projectile. When used, the reflector 14 is preferably made of a very thin Lithium foil and, as a practical matter, needs only be several microns thick. Again, other reflective materials may be used. The import here is that a reflector 14 be useful for reflecting radiation (e.g. microwave power) back into the pusher medium 16 for absorption. To interact with the radiation, the pusher medium 16 is preferably a mixture of frozen deuterium (D₂) and metal particles 20. And, the window 18 needs to be made of a material that is transparent to radiation (microwave power), such as diamond or sapphire.

With the above in mind, the composition of the pusher medium 16 is of particular interest. In the pusher medium 16 the metal particles 20 can be made of any suitable conductor, such as Lithium (Li), Beryllium (Be) or Carbon (C). Further, the metal particles 20 can be shaped as wires, spheres or discs. Preferably, however, the metal particles 20 are shaped as discs that have a radius “a” of about four microns, and a thickness “h” of about four-tenths of a micron. Importantly, the metal particles 20 are dispersed through the frozen deuterium (D₂) with a separation distance between the particles 20 that is less than approximately five microns. Also, they are dispersed in a concentration that is less than ten percent of the volume of the pusher medium 16. Of particular importance here is that the macroscopic conductivity of the pusher medium 16 is optimized. This is done by keeping the size of the particles 20, and the inter-particle spacing between particles 20, well below the mm-sized wavelength “λ” of the microwave power that will be used to heat the pusher medium 16.

In combination, the components of the module 10 can be joined together in any manner well known in the pertinent art. As shown in FIG. 1, the module 10 is assembled as a rectangular solid having a height “d” and a width “w”. For most applications, the dimensions “d” and “w” will be in a range of about 2-20 millimeters. These dimensions, of course, can be varied according to the requirements of the particular application and, in some, the width may be equal to the height (e.g. d=w). The overall length of the module 10 will also depend on requirements of the particular application. For instance, requirements such as how much fuel is required for the fuel pellet 12, and how much propellant is needed for the pusher medium 16 may cause the dimensions of the module 10 to be varied. In each case, however, it is always important that the cross sectional area of the module 10 (e.g. w×d) conform to, and be compatible with, the cross sectional area of the waveguide that will be used for activation of the module 10.

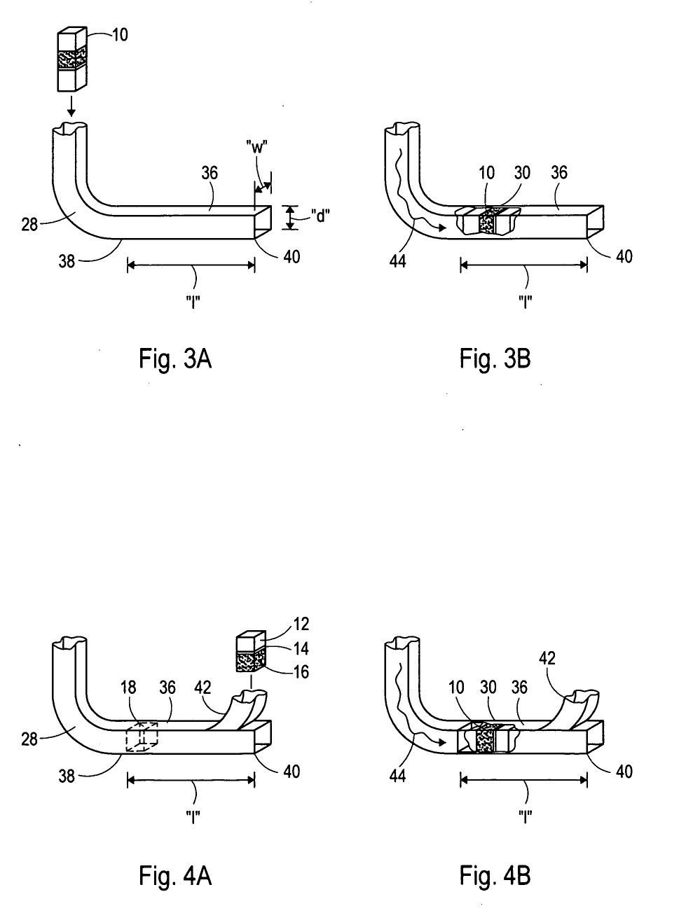

Turning now to FIG. 2, a particular environment in which the module 10 of the present invention may be used is shown to be a tokamak, generally designated 22. For purposes of discussion, the tokamak 22 is shown to contain a plasma 24 that is confined within a chamber 26. As intended for the present invention, the purpose here is to fuel the plasma 24. To do this, the module 10 is pre-positioned in the tokamak 22, and it is then activated to inject the fuel pellet 12 into the plasma 24. For example, in an embodiment of the present invention as shown in FIG. 2, a module 10 is advanced through a waveguide 28 and is pre-positioned at a point 30 in the waveguide 28. Once the module 10 is at the point 30, microwave power is radiated into the waveguide 28 from a gyrotron 32. This microwave power then activates the module 10 by heating the pusher medium 16 and causing it to rapidly expand as a gas. The intended consequence of this is that the fuel pellet 12 is ejected at a very high velocity (e.g. 3 km/sec) from the waveguide 28, and injected into the plasma 24. Various embodiments for doing all of this are best seen with reference to FIGS. 3A, 3B, 4A, and 4B.

Referring first to FIG. 3A, it will be seen that the waveguide 28 includes a straight section 36. Specifically, the straight section 36 is shown to have a length “I” that extends from a first end 38 to a second end 40. Also, the waveguide 28 is shown to have a cross sectional area that is defined by a height “d” and a width “w”. With reference to the dimensions of module 10 discussed above, it is to be appreciated that there will necessarily be some tolerance between the respective “d” and “w” of the module 10 and “d” and “w” of the waveguide 28. Nevertheless, this tolerance can, and should, be minimized. Again, this can be done with operational considerations in mind. On this point, again for operational reasons, the particular shape of the cross section of guidewave 28 is essentially a matter of design choice (e.g. circular, rectangular, oval etc.).

Referring now to FIG. 4A, in an alternate embodiment of the present invention, the waveguide 28 is shown to include a chute 42 that is located between the ends 38 and 40 of straight section 36. In all important respects, for both embodiments of the waveguide 28 (FIG. 3A and FIG. 4A) the respective straight sections 36 are functionally identical. Most important, the sections 36 are straight so there will be no structural limitations to the rapid linear acceleration of any fuel pellet 12 when it is ejected through the end 40 of waveguide 28 by the activation of a module 10.

In the operation of the present invention, there are essentially two ways by which a module 10 can be positioned in the straight section 36 of a waveguide 28 for activation. The first is illustrated in FIGS. 3A and 3B. There it is to be appreciated that a module 10 is pre-assembled outside the tokamak 22 before it is placed in the waveguide 28. Once in the waveguide 28, the module 10 is allowed to travel through the waveguide 28, at a relatively low velocity (e.g. 50 m/sec), until it reaches the point 30 (see FIG. 2 and FIG. 3B). At the point 30, the module 10 is activated. Specifically, with the module 10 at point 30, the gyrotron 32 is energized to direct radiation 44 through the waveguide 28. The radiation 44 then interacts with the pusher medium 16 of the module 30, to heat the pusher medium 16 and thereby cause a gaseous expansion that will eject the fuel pellet 12 of module 10 from the waveguide 28. As indicated in FIG. 2, the ejection of a fuel pellet 12 will cause it to travel along the path 34, and into the plasma 24. There, the fuel pellet 12 is used to fuel the plasma 24.

The second way by which a module 10 can be positioned in the straight section 36 of a waveguide 28 is illustrated in FIGS. 4A and 4B. In this case, the straight section 36 is modified in at least two aspects. For one, the window 18 is permanently affixed in the section 36 at the point 30. For another, only the fuel pellet 12, reflector 14 (if used), and the pusher medium 16 are pre-assembled outside the tokamak 22. As shown in FIG. 4B, after the combination of fuel pellet 12, reflector 14 and pusher medium 16 has been inserted through the chute 42, a module 10 is effectively assembled at the point 30. As with the embodiment of the invention shown in FIGS. 3A and 3B, the module 10 is then activated.

While the particular Microwave-Powered Pellet Accelerator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A module useable with a source of microwave energy for ejecting a pellet from a waveguide, wherein the waveguide has a predetermined cross-sectional area and the module comprises:
a pellet dimensioned to substantially conform with the cross-sectional area of the waveguide;
a window dimensioned to substantially conform with the cross-sectional area of the waveguide; and
a pusher medium positioned between said pellet and said window to absorb radiation from the source of microwave energy when radiation is directed therefrom into the waveguide and through said window to cause a gaseous expansion of the pusher medium to eject said pellet from the waveguide.

2. A module as recited in claim 1 further comprising a metallic reflector positioned between said pellet and said pusher medium.

3. A module as recited in claim 2 wherein said metallic reflector is a Lithium foil.

4. A module as recited in claim 1 wherein said window is fixedly positioned in the waveguide.

5. A module as recited in claim 1 wherein said pellet is made of deutritium-tritium (DT).

6. A module as recited in claim 1 wherein said window is made of a material selected from a group consisting of diamond and sapphire.

7. A module as recited in claim 1 wherein said pusher medium comprises frozen deuterium (D₂) and metallic particles.

8. A module as recited in claim 7 wherein the metallic particles are disc-shaped conductors made of lithium (Li) having a radius “a” of about four microns (a=4 μm) and a thickness “h” of about four-tenths of a micron (h=0.4 μm).

9. A module as recited in claim 8 wherein the microwave energy has a wavelength “λ” greater than one millimeter (λ>1 mm) and said pusher medium has a separation distance between metallic particles of approximately five microns.

10. A module as recited in claim 8 wherein the source of microwave energy is a gyrotron having a high power radiation output in a range between approximately one and two megawatts (1-2 MW).

11. A module as recited in claim 1 wherein the waveguide has a rectangular cross sectional area and includes a substantially straight section having a first end and a second end.

12. A module as recited in claim 11 wherein the pellet is ejected from the waveguide through the second end thereof and into a plasma in a tokamak.

13. A system for providing fuel to a tokamak which comprises:
a waveguide having a first end and a second end with a substantially straight section therebetween, said waveguide having a predetermined, substantially uniform cross-sectional area in said straight section;
a gyrotron for radiating microwave energy into the straight section of said waveguide through the first end thereof; and
a module positioned in the straight section of said waveguide, wherein said module comprises a pellet and a window, each dimensioned to substantially conform with the cross-sectional area of the waveguide, and a pusher medium positioned between said pellet and said window to absorb radiation from the gyrotron when radiation is directed therefrom into the waveguide and through said window to cause a gaseous expansion of the pusher medium to eject the pellet from said waveguide.

14. A system as recited in claim 13 further comprising a Lithium foil positioned between the pellet and the pusher medium.

15. A system as recited in claim 13 wherein the pellet is made of deutritium-tritium (DT), the window is made of a material selected from a group consisting of diamond and sapphire, and the pusher medium comprises frozen deuterium (D₂) and metallic particles.

16. A system as recited in claim 15 wherein the metallic particles are disc-shaped conductors made of lithium (Li) having a radius “a” of about four microns (a=4 μm) and a thickness “h” of about four-tenths of a micron (h =0.4 μm), with a separation distance between metallic particles of approximately five microns in said pusher medium.

17. A system as recited in claim 16 wherein said gyrotron has a high power radiation output in a range between approximately one and two megawatts (1-2 MW), and wherein microwave energy in the radiation has a wavelength “λ” greater than one millimeter (λ>1 mm).

18. A method for fueling a tokamak using a waveguide and a gyrotron, wherein a substantially straight section of the waveguide has a first end and a second end and a predetermined, substantially uniform cross-sectional area, with the gyrotron located to direct microwave energy into said straight section through the first end thereof, said method comprising the steps of:
positioning a window in the straight section of the waveguide;
juxtaposing a pusher medium against the window with the pusher medium located between the window and a pellet; and
radiating microwave energy from the gyrotron into the waveguide and through the window to cause a gaseous expansion of the pusher medium to eject the pellet from the waveguide, through the second end thereof, to fuel a plasma in the tokamak.

19. A method as recited in claim 18 wherein said juxtaposing step is accomplished before said positioning step to create a module, and wherein said method further comprises the step of inserting said module into said straight section of the waveguide through the first end thereof.

20. A method as recited in claim 18 wherein said positioning step is accomplished by affixing the window in the substantially straight section thereof, and wherein the juxtaposing step is accomplished by inserting the pusher medium and the pellet through the second end of the substantially straight section of the waveguide.
